(19) United States
(12) Patent Application Publication
(10) Pub. No.: US 2002/0175200 A1
(43) Pub. Date: Nov. 28, 2002

(54) Air valve switch of an air brad nailer

(76) Inventor: Chung Ho Liu, Chino Hills, CA (US)

Correspondence Address: CHUNG-HO LIU, 4972 Heritage DR, Chino Hills, CA, 91709, US

(21) Appl. No.: 09/919,218

(22) Filed: Aug. 1, 2001

(30) Foreign Application Priority Data
May 24, 2001 (TW) 90208504

(51) Int. Cl. B25C 1/04

(52) U.S. Cl. 227/130

(57) ABSTRACT

The present invention relates to an air valve switch of an air brad nailer which includes a valve block, a valve shaft, a compression spring and two sealing rings. The valve block contains an axial through hole and a plurality of guide holes. A hindering rim is situated in the through hole so that the valve shaft can be plugged from the rear side of the through hole of the valve block into the front side thereof. Moreover, a thickened section rests against the hindering rim inside the through hole. And the compression spring is installed at the rear end of the valve shaft.

### BACKGROUND OF THE INVENTION

1. Field of the Invention

The present invention relates to an air valve switch of an air brad nailer, and more particularly, a nailer which has a compact configuration, which is easily manufactured and whose production costs are low.

2. Description of the Prior Art

The so-called air valve switch of an air brad nailer is mounted on the trigger of the nailer. As shown in FIGS. 1 and 2, a conventional air valve switch includes a valve cap 10, a conic valve shaft 11, a valve seat 12 and a valve seat basis 13 all of which are assembled in a receiving groove 16 near the trigger 15 of the nailer 14. Meanwhile, the receiving groove 16 furthermore has an airway 17 which communicates with an air container 18 of the nailer 14.

When the trigger 15 is pulled, the valve shaft 11 is brought to slide inwardly so that the tipped conic end 111 rests against the entrance 122 of the airway 17. Meanwhile, all of the gas flows to the rear side of the piston 19 which is driven to project therefrom for completing the nailing. To the contrary, when the trigger 15 is in the ordinary state, the gas flows into the air chamber 191 in front of the piston 19 because of the guidance of the airway 17 and the guide holes of the valve block 12 until a pressure equilibrium of the front and rear side of the piston 19 is reached in a standstill state.

However, the aforementioned product has a complicated configuration and requires a higher precision. Moreover, the constant contact of the tipped conic end 111 of the valve shaft 11 with the entrance 122 leads to a higher rate of wear which has an inverse impact upon the airtightness. Accordingly, it is no more used in the industry.

In order to effectively reduce the defect rate of the above-mentioned products, another conventional air valve switch of an air brad nailer is developed. The structure of the valve cap 20 and the valve shaft 21 are changed. When the valve shaft 21 is changed. When the valve shaft 21 is pressed, the sealing ring 22 is situated between the guide holes 23 of the valve cap 20 and the guide holes 25 of the valve block 24 for blocking the airflow.

The above two products also have the defects of complicate components and difficult assembly. The inventor of the present invention developed a product, as shown in FIG. 4. The all-in-one valve body 30 substitutes the conventional valve cap 10, 26 and the valve block 12, 24. Moreover, a valve shaft 31 in coordination with a spring 32 is plugged in an internal hole 33 of the valve body 30. When the valve shaft 31 is pressed, the sealing ring 34 is situated between the inlet hole 35 and outlet hole 36 of the valve body 30 for blocking the airflow.

Though the above third product can effectively resolve the problems of the first and second products, it's troublesome that the valve shaft 31 constantly protrudes outwardly due to the spring 32 in assembly. Meanwhile, the secondary trigger 38 inside of the trigger 37 is constantly pushed so that the operational accuracy is influenced because the secondary trigger 38 and the end of the safety arched arm are in constant contact with each other.

### SUMMARY OF THE INVENTION

It is a primary object of the present invention to remove the above-mentioned drawbacks and to provide an air valve switch of an air brad nailer in which the valve shaft directly blocks the airway of the air brad nailer and the guide holes of the valve body so that the configurations of the valve body and the channel between the airway and the guide hole are simplified.

### BRIEF DESCRIPTION OF THE DRAWINGS

The accomplishment of this and other objects of the invention will become apparent from the following description and its accompanying drawings of which:

FIG. 1 is a schematic drawing of a conventional air brad nailer, showing the position of the air valve switch thereof;

FIG. 2 is a perspective exploded view of a first conventional air valve switch;

FIG. 3 is a perspective exploded view of a second conventional air valve switch;

FIG. 4 is a perspective exploded view of a third conventional air valve switch;

FIG. 5 is a perspective exploded view of a first preferred embodiment of the present invention;

FIG. 6 is a schematic drawing of the first preferred embodiment of the present invention after assembly;

FIG. 7 is a perspective exploded view of a second preferred embodiment of the present invention; and

FIG. 8 is a schematic drawing of the second preferred embodiment of the present invention after assembly.

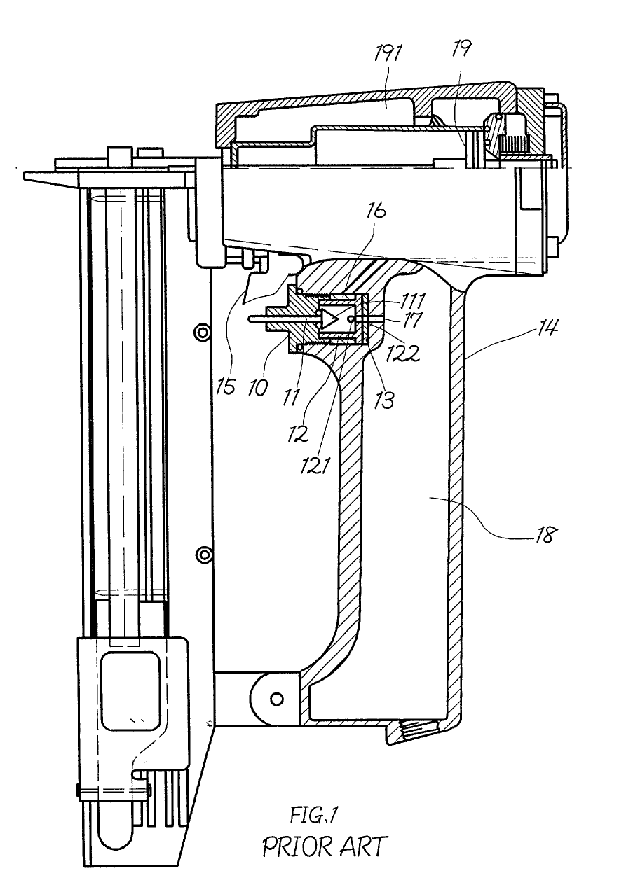

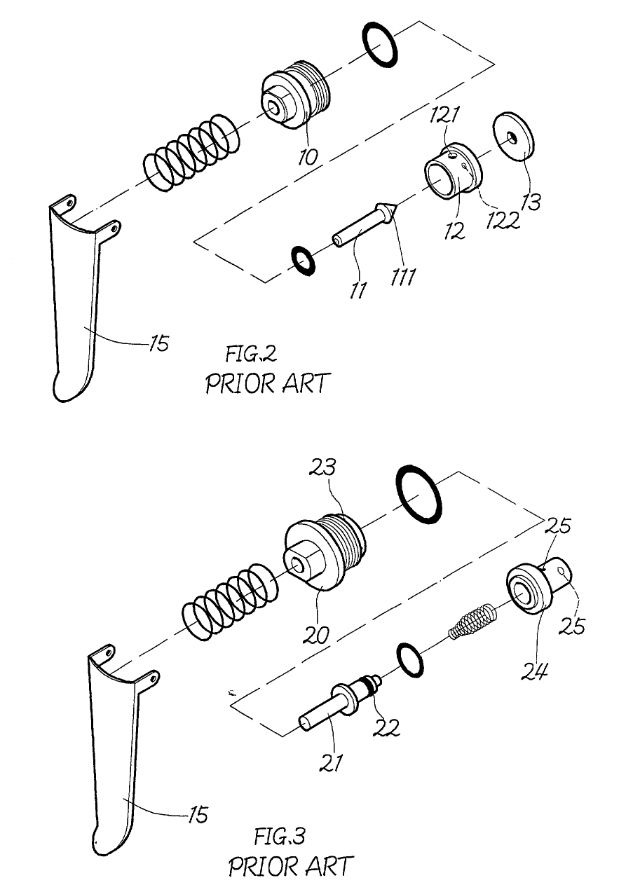

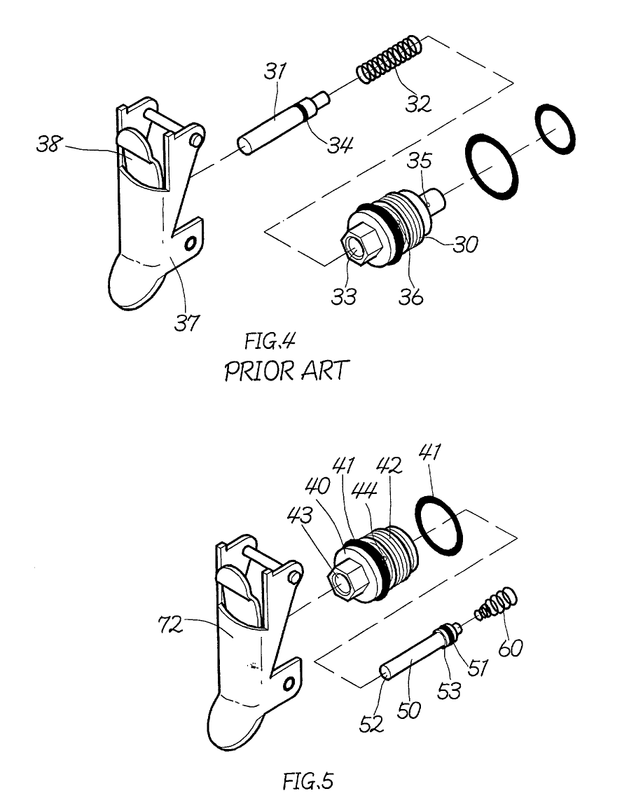

### DETAILED DESCRIPTION OF THE PREFERRED EMBODIMENT

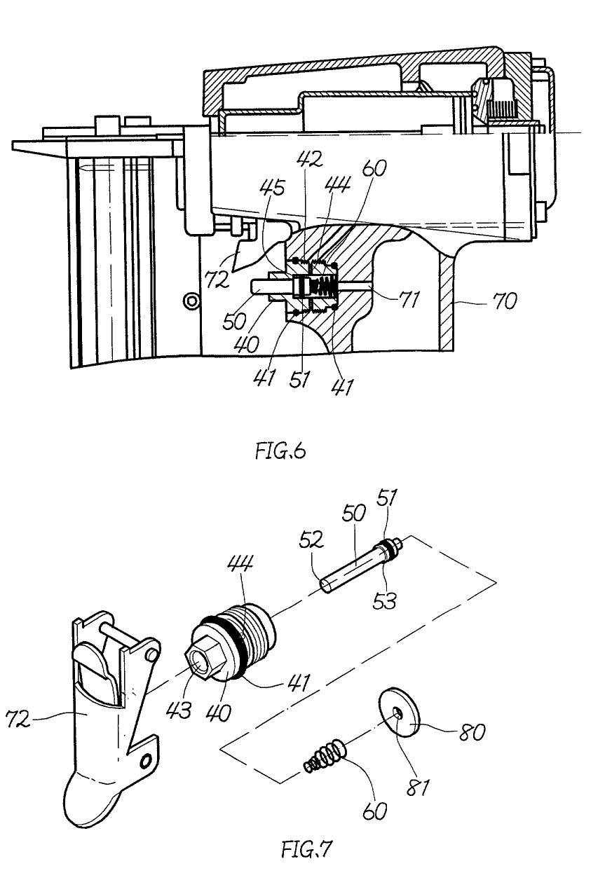

First of all, referring to FIGS. 5 and 6, a preferred embodiment of the present invention mainly includes a valve block 40, a valve shaft 50 and a compression spring 60.

Two sealing rings 41 are inserted on the valve block 40. The valve block 40 includes a male thread 42 outside and an axial through hole 43 inside. A plurality of guide holes 44 on the outside of the valve block 40 are connected to the through hole 43 in which a hindering rim 45 is situated.

A sealing ring 51 is inserted on the valve shaft 50 which is then plugged from the rear side of the through hole 43 of the valve block 40 into the front side thereof so that the front end 52 of the valve shaft 50 projects from the through hole 43 of the valve block 40. Moreover, a thickened section 53 rests against the hindering rim 45 inside the through hole 43.

The compression spring 60 is installed at the rear end of the valve shaft 50 and lies between the valve shaft 50 and an airway 71 of the brad nailer 70.

Based on the assembly of the above-mentioned components, the sealing ring 51 of the valve shaft 50 lies at the foremost end of the valve block 40 in the ordinary state so that the guide hole 44 of the valve block 40 communicates with the airway 7 of the brad nailer 70. When a trigger 72 is pulled and the valve shaft 50 is brought to slide inwardly, the sealing ring 51 is situated between the guide hole 44 of the valve block 40 and the airway 7. Accordingly, the channel of the airflow is blocked.

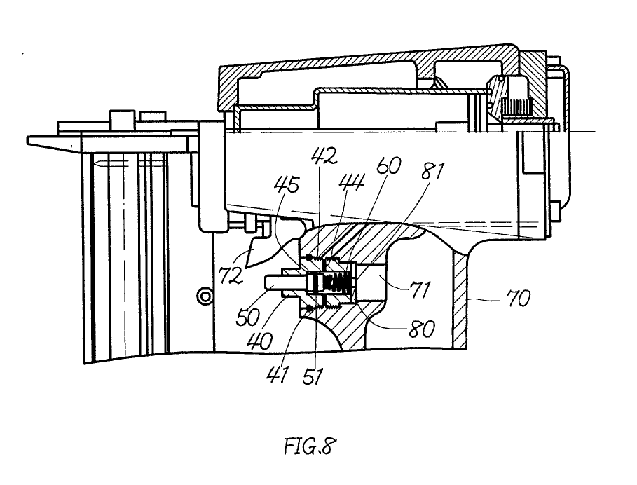

In accordance with different specifications of the brad nailer 70, different amount of gas air is necessary. The more gas the brad nailer 70 requires, the larger the diameter of the airway 7 is. As shown in FIGS. 7 and 8, when a disk 80 with a middle hole 81 is added to the rear end of the valve block 40, this is then applicable to another brad nailer 70 with larger diameter.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claim.

What is claimed is:

1. An air valve switch of an air brad nailer mainly comprising:
a valve block having two sealing rings inserted on the outside thereof, a male thread outside thereof, an axial through hole inside thereof and a plurality of guide holes on the outside of thereof in connection with said through hole in which a hindering rim is located;
a valve shaft having a sealing ring inserted thereon whereupon said valve shaft is plugged from the rear side of said through hole of said valve block into the front side thereof so that the front end of said valve shaft projects from said through hole of said valve block, and a thickened section resting against said hindering rim inside said through hole;
a compression spring installed at the rear end of said valve shaft and situated between said valve shaft and an airway of said brad nailer;
wherein, based on the assembly of the above-mentioned components, said sealing ring of said valve shaft lies at the foremost end of said valve block so that said guide hole of said valve block communicates with said airway of said brad nailer; and
wherein, when a trigger is pulled and said valve shaft is brought to slide inwardly, said sealing ring is situated between said guide hole of said valve block and said airway so that the channel of the air flow is blocked.
